(19) United States
(12) Patent Application Publication
(10) Pub. No.: US 2011/0172961 A1
(43) Pub. Date: Jul. 14, 2011

(54) MANAGEMENT APPARATUS AND IMAGE FORMING APPARATUS MANAGEMENT METHOD

(75) Inventor: Jin Sunata, Yokohama-shi (JP)

(73) Assignee: CANON KABUSHIKI KAISHA, Tokyo (JP)

(21) Appl. No.: 12/986,009

(22) Filed: Jan. 6, 2011

(30) Foreign Application Priority Data
Jan. 8, 2010 (JP) 2010-002795

(51) Int. Cl. G06F 19/00; G03G 15/00; G06F 15/00

(52) U.S. Cl. 702/179; 399/8; 399/44; 702/188

(57) ABSTRACT

A system of an apparatus collects, from a plurality of forming apparatuses, information about a status of occurrence of an error occurring on the plurality of forming apparatuses and a utilization environment of the plurality of forming apparatuses, executes control, if an error has frequently occurred and that the utilization environment has varied, for notifying information indicating that the error has frequently occurred on the plurality of forming apparatuses together with information about the varied utilization environment, and executes control, if the error has frequently occurred and the utilization environment has not varied, for notifying information indicating that the error has occurred on the plurality of forming apparatuses together with the information about the utilization environment.

### BACKGROUND OF THE INVENTION

1. Field of the Invention

The present invention relates to a management apparatus capable of communicating with a plurality of image forming apparatuses and a method for managing each image forming apparatus.

2. Description of the Related Art

Japanese Patent Application Laid-Open No. 2000-267522 discusses a method for checking the amount of light emitted by a fluorescent lamp included in an image forming apparatus and for checking the temperature of a scanner. The conventional method stores a result of the detection on a random access memory (RAM) of the image forming apparatus.

A conventional method, with respect to one image forming apparatus, compares a threshold value set to the image forming apparatus and a detected temperature and determines whether a failure or a malfunction has occurred based on the result of the comparison. However, the above-described conventional method cannot appropriately analyze the cause of an error. More specifically, an error may very frequently occur due to the state of the installation location (an apparatus utilization environment) of an image forming apparatus, such as high temperature or humidity. If the above-described conventional method is used, the cause of a detected error or failure cannot be easily analyzed or determined as to whether the detected error or failure has occurred uniquely on the image forming apparatus or whether the detected error or failure has occurred due to a cause occurring primarily because of the state of the installation environment of the image forming apparatus.

On the other hand, if an error has occurred on an image forming apparatus and when the error is notified to a service person, the service person provides a service, such as a maintenance service. The type of the service to be provided is determined according to a result of analysis of the notified error and the cause thereof recognized by the analysis.

Accordingly, if the conventional method is used, the cause of the error cannot be appropriately identified. Therefore, in this case, an appropriate service cannot be provided to a customer who uses the image forming apparatus. More specifically, the service to be provided in this case includes a periodical maintenance executed by an appropriate interval and counseling for an appropriate method for operating the image forming apparatus as well as an operation for recovering from the error. However, the conventional method cannot appropriately provide the above-described type of services to the customer.

### SUMMARY OF THE INVENTION

According to an aspect of the present invention, an apparatus includes a collection unit configured to collect, from a plurality of forming apparatuses, information about a status of occurrence of an error occurring on the plurality of forming apparatuses and an utilization environment in which the plurality of forming apparatuses is utilized, an error determination unit configured to determine whether an error has frequently occurred on the plurality of forming apparatuses within a predetermined time period based on the collected information about the status of occurrence, an environment determination unit configured to determine whether a variation satisfying a predetermined condition has occurred to the utilization environment based on the collected information about the utilization environment, and a control unit configured, if an error has frequently occurred and the utilization environment has varied, to execute control for notifying information indicating that the error has frequently occurred together with information about the varied utilization environment, wherein the control unit is configured, if the error has frequently occurred and the utilization environment has not varied, to notify information indicating that the error has occurred together with the information about the utilization environment.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an example of a device management system to which a management apparatus, which implements an exemplary embodiment of the present invention, can be applied.

FIG. 2 is a block diagram illustrating an exemplary configuration of an image forming apparatus 101.

FIG. 3 is a block diagram illustrating an exemplary configuration of a management apparatus 102.

FIG. 4 is a block diagram illustrating exemplary processing modules included in the image forming apparatus 101.

FIG. 5 is a block diagram illustrating exemplary processing modules included in the management apparatus 102.

FIG. 6 illustrates an example of a group setting screen.

FIG. 7 illustrates an example of a notification setting screen via which an e-mail notification setting (a monitoring level setting) is performed for each group and each type of error.

FIG. 8 is a flow chart illustrating an exemplary flow of processing for determining an error occurring on, an environment of installation of, and a notification to be transmitted to a plurality of grouped image forming apparatuses according to an exemplary embodiment of the present invention.

FIG. 9 illustrates an example of a case where a frequency of occurrence of an error has exceeded the monitoring level setting.

FIG. 10 is a graph indicating an average of information about the temperature and the humidity of a specific image forming apparatus included in a monitoring target image forming apparatus group, collected therefrom.

FIG. 11 is a table storing the sum total of the number of prints collected from the image forming apparatus.

FIG. 12 illustrates an example of an e-mail notified in step S809 of the flow chart of FIG. 8.

### DESCRIPTION OF THE EMBODIMENTS

Various exemplary embodiments, features, and aspects of the invention will be described in detail below with reference to the drawings.

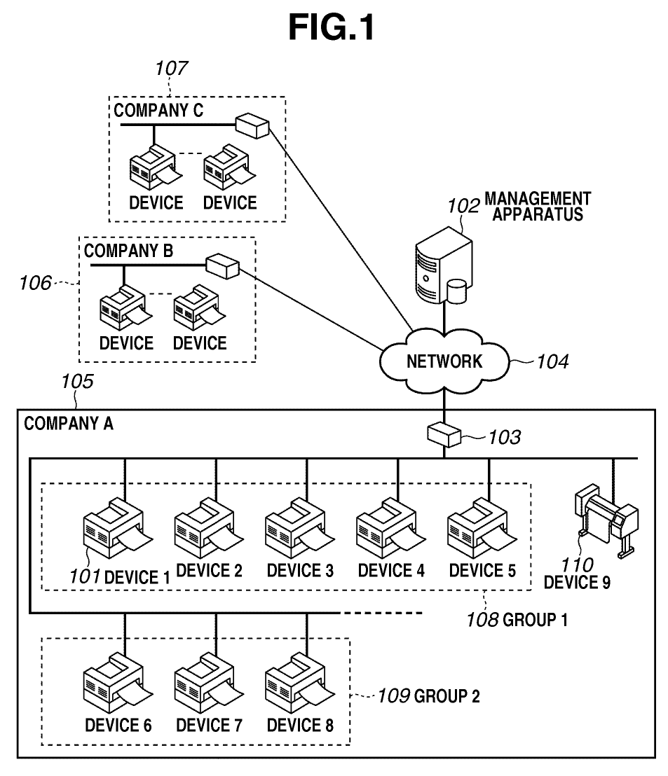

FIG. 1 illustrates an example of a device management system to which a management apparatus, which implements an exemplary embodiment of the present invention, can be applied.

Referring to FIG. 1, an image forming apparatus 101 (the device 1), which is an image forming apparatus to be monitored (hereinafter may also be referred to as a “monitoring target image forming apparatus 101”), is installed in a specific customer environment (for example, a company A 105). A management apparatus 102 manages a status of the image forming apparatus 101. The management apparatus 102 is connected with the image forming apparatus 101 via a network device 103, such as a router. Accordingly, the management apparatus 102 can communicate with the image forming apparatus 101. The image forming apparatus 101 can notify the management apparatus 102 of various information about the image forming apparatus 101 itself via a network 104, such as the Internet.

In the following description, each image forming apparatus managed by the management apparatus 102 as illustrated in FIG. 1 is also referred to as a “device”. In addition, a company B 106 and a company C 107, which are different from the company A 105, may also be connected to the network 104 as well as the company A 105.

In a business site of the company A 105, image forming apparatuses (i.e., devices 2 through 8) other than the image forming apparatus 101 are installed. An inkjet image forming apparatus 110 (a device 9), such as a wide format inkjet printer, can be installed on the business site of the company A 105. Each image forming apparatuses other than the image forming apparatus 101 (i.e., the devices 2 through 9) also can notify the status of the apparatus itself to the management apparatus 102 via the network 104 as the image forming apparatus 101 can.

A local area network (LAN), a leased line, or the Internet can be used as the network 104. A plurality of image forming apparatuses may be managed in the unit of an installation location (i.e., a room or a building) or a business unit (i.e., a division or a department). In the example illustrated in FIG. 1, ranges of the target of management 108 and 109 are schematically illustrated by using dotted lines.

In a customer environment, a plurality of image forming apparatuses may often be installed in substantially the same environment. If an error has occurred, it can be analyzed whether each image forming apparatus has been installed in an unusual adverse environment, such as a place outside the business site, based on environmental information detected on and acquired from the image forming apparatus.

If an image forming apparatus has been installed in a hostile (i.e., hot and humid) environment, the frequency of occurrence of an error or a paper jam (hereinafter simply referred to as a “jam”) occurring on the image forming apparatus tends to become higher compared to a case where the image forming apparatus is installed and operated in a normal environment. If an image forming apparatus has been used in a region of a poor power supply, a power supply unit of the image forming apparatus may tend to fail very frequently. In addition, the same product may often be utilized on a plurality of image forming apparatuses installed in a plurality of different environments of the same customer.

The quality of a sheet may slightly vary due to a raw material or a manufacturer thereof in terms of its thickness and the evenness on the surface thereof. In an environment in which a plurality of image forming apparatuses is installed, a jam may occur due to the characteristic of the model type of each image forming apparatus and the sheet used on each image forming apparatus.

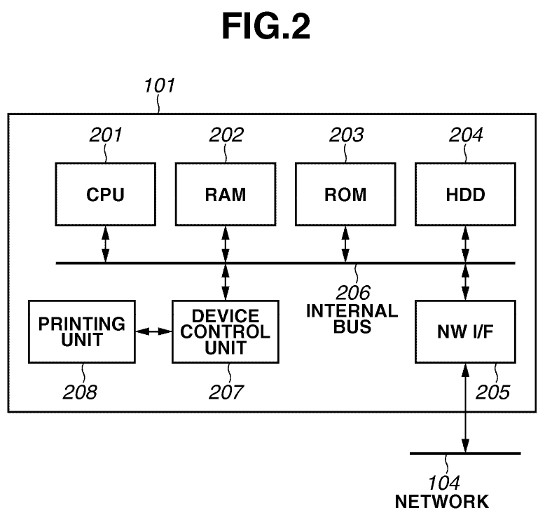

FIG. 2 is a block diagram illustrating an exemplary configuration of the image forming apparatus 101. In the present exemplary embodiment, the other image forming apparatuses (i.e., the devices 2 through 9) have the same configuration. Accordingly, in the following description, the image forming apparatus 101 will be primarily described as a representative apparatus of all the devices. The image forming apparatus 101 can be applied to an image forming apparatus, such as a digital multifunction peripheral (MFP), a facsimile machine, a laser beam printer, an inkjet printer, and a scanner apparatus.

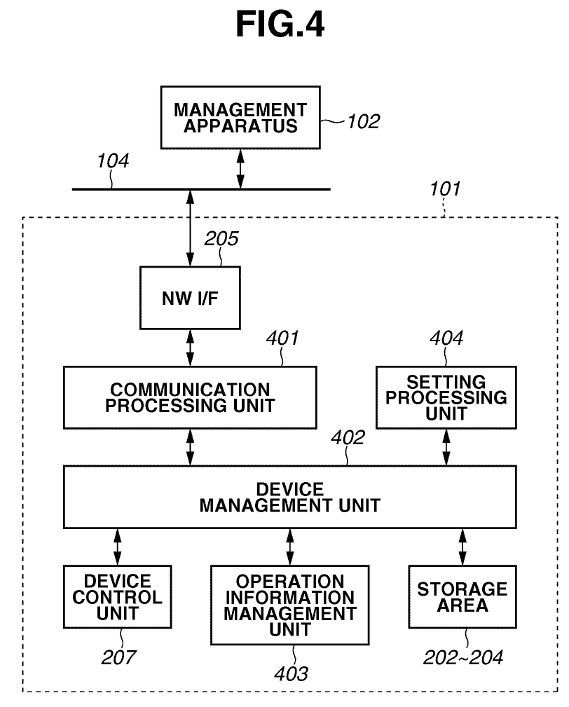

The image forming apparatus 101 includes a central processing unit (CPU) 201, which loads and executes a program (including a program that implements each processing module illustrated in FIG. 4, which will be described in detail below) from a read-only memory (ROM) 203. The CPU 201 controls the operation of each of a random access memory (RAM) 202, the ROM 203, a storage device 204, and a network interface (NW I/F) 205 via an internal bus 206.

In addition, the image forming apparatus 101 includes the RAM 202, the ROM 203, the storage device 204, such as an HDD or a non-volatile memory, the NW I/F 205, a device control unit 207, and a printing unit 208. The image forming apparatus 101 can include a reading unit (not illustrated). In addition, the reading unit (not illustrated) can include an auto document feeder (ADF).

The CPU 201, the RAM 202, the ROM 203, the storage device 204, the network I/F 205, the device control unit 207, and the printing unit 208 are in communication with one another via the internal bus 206. The RAM 202 functions as a work memory and a work area for the CPU 201.

The device control unit 207 controls the printing unit 208 (and a reading unit (not illustrated) and an ADF unit (not illustrated)). The network I/F 205 functions as an interface for interactive data communication between the image forming apparatus 101 and an external network device or a personal computer (PC) via the network 104.

The storage device 204 includes an HDD or a non-volatile memory, such as a flash memory. The storage device 204 functions as an external storage device, which stores image data, and can also store, instead of the backup RAM 202, counter information, system information, and status information. The CPU 201 executes processing for recording image data on a recording medium, such as the storage device 204.

The device control unit 207 and the printing unit 208 execute control on consumption of consumables and control of printing. More specifically, the device control unit 207 and the printing unit 208 are capable of notifying information about the status of the consumables and the printing unit to the management apparatus 102 under control of the CPU 201 via the NW I/F 205 and the network 104. The printing unit 208 includes a sheet detection sensor on a sheet conveyance path. Accordingly, the printing unit 208 can detect a paper jam, if any occurs. In addition, the printing unit 208 includes a temperature sensor and a humidity sensor for measuring the temperature and the humidity inside and/or outside (around) the printing unit 208.

Furthermore, the CPU 201 executes control for storing the number of prints on the storage device 204. The reading unit (not illustrated) includes a document detection sensor on the document feeding and conveyance path. Accordingly, the reading unit is capable of a jam of a document, if any occurs on the ADF (hereinafter may also be referred to as an “ADF jam”).

The image forming apparatus 101 notifies information about the apparatus utilization environment to the management apparatus 102 via the network 104 including environmental information, such as the temperature and the humidity, and counter information, such as the number of prints, as well as information about an error, such as a jam, an ADF jam, and other errors detected in the above-described manner under control of the CPU 201.

The counter information includes various information other than the number of prints, which is acquired by using counters. The other information included in the counter information includes the number of times of use of each part of the image forming apparatus. The counter that counts the number of times of use of each part is referred to as a “part counter”. If an extremely or abnormally high temperature value or humidity value (i.e., a value too high to maintain the normal operation state of the apparatus or a value that may indicate that the apparatus has apparently failed) is detected, the image forming apparatus 101 can notify the management apparatus 102 that the abnormally high temperature or humidity value has been detected as the above-described error information. The information about the apparatus utilization environment (hereinafter may be simply referred to as “apparatus utilization environment information”) can include a value of voltage supplied to the image forming apparatus 101.

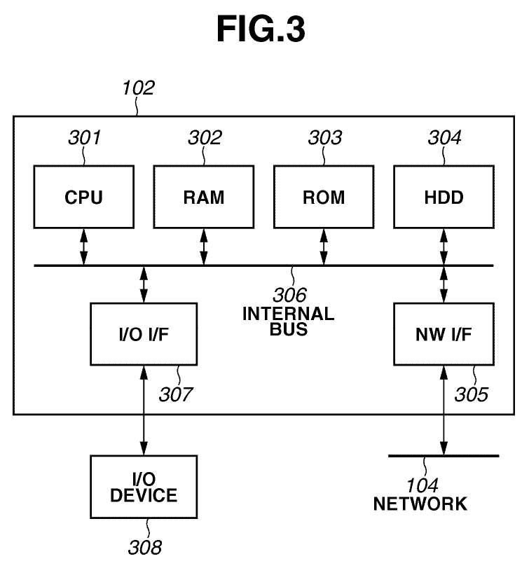

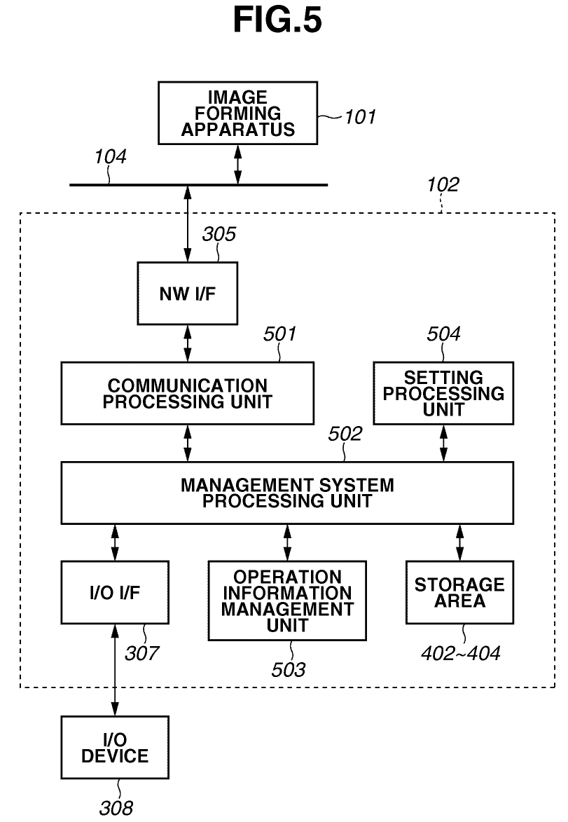

FIG. 3 is a block diagram illustrating an exemplary configuration of the management apparatus 102. The management apparatus 102 monitors and manages the image forming apparatus 101. An information processing apparatus, such as a PC or a server can be used as the management apparatus 102. The management apparatus 102 includes a CPU 301, which loads and executes a program (including a program that implements each processing module illustrated in FIG. 5, which will be described in detail below) from a ROM 303. The CPU 301 controls the operation of each of a RAM 302, the ROM 303, a storage device 304, a NW I/F 305, and an input/output (I/O) I/F 307 via an internal bus 306.

The components of the management apparatus 102, such as the CPU 301, the RAM 302, the ROM 303, the storage device 304, such as an HDD or a non-volatile memory including a flash memory, the NW I/F 305, and the I/O I/F 307 are in communication with one another via an internal bus 306. The NW I/F 305 is an interface for interactive data communication between the management apparatus 102 and an external network device or a PC via the network 104.

The storage device 304, which functions as an external storage device, stores information to be registered on the image forming apparatus 101, and can also store the counter information and the error information instead of the backup RAM 302.

I/O devices 308, such as a display, a keyboard, or a mouse, is connected to the I/O I/F 307. An operator of the management apparatus 102 can execute a setting and management on the management apparatus 102 via the I/O device 308. However, for a method for inputting and outputting information, the present exemplary embodiment is not limited to the I/O device 308. More specifically, a user interface (UI) having the same function as that of the I/O device 308 can be provided to another information processing apparatus via the network 104. In other words, the management apparatus 102 can function as a hypertext transport protocol (HTTP) server by using a protocol, such as HTTP, by using a program. In this case, the setting and management on the management apparatus 102 can be executed via a web browser included in an external apparatus.

FIG. 4 is a block diagram illustrating exemplary processing modules included in the image forming apparatus 101. Referring to FIG. 4, the image forming apparatus 101 includes processing modules, such as a communication processing unit 401, a device management unit 402, an operation information management unit 403, and a setting processing unit 404. The communication processing unit 401 controls the NW I/F 205 when the image forming apparatus 101 accesses (executes data communication with) the management apparatus 102 via the network 104. The communication processing unit 401 sends and receives data to and from the external management apparatus 102 according to an instruction input by the device management unit 402, which controls the entire operation of the image forming apparatus 101.

The communication processing unit 401 includes a function for processing a communication protocol. The communication processing unit 401 notifies the status of the image forming apparatus 101 to the management apparatus 102, and receives data from the management apparatus 102 by using a general protocol, such as simple mail transfer protocol (SMTP) or hypertext transfer protocol (HTTP).

The device management unit 402 will be described in detail below. The device management unit 402 can manage and control the operation of the entire image forming apparatus 101. More specifically, the device management unit 402 can input an instruction to the printing unit 208 and acquire information generated on the printing unit 208 via the device control unit 207. More specifically, the device management unit 402 can acquire various information, such as the end of printing, no sheet in paper feed unit, and the mounting status and the remaining quantity or amount of consumables for printing, from the printing unit 208.

In addition, the device management unit 402 executes control for cancelling printing or prompting the user to replace a consumable with a new one based on the above-described information. In addition, the device management unit 402 can acquire error information and information about the apparatus utilization environment from the printing unit 208.

The device management unit 402 operates in cooperation with the operation information management unit 403 and the setting processing unit 404. The operation information management unit 403 manages operation information about the image forming apparatus, such as the status of consumables used on the image forming apparatus, error information about an error occurring on the image forming apparatus, and the above-described apparatus utilization environment information. The setting processing unit 404 executes processing for changing a setting of the image forming apparatus, which is executed via the network 104. In addition, the setting processing unit 404 manages the current setting of the image forming apparatus via the network 104.

In addition, the device management unit 402 notifies the management apparatus 102 of the setting of the image forming apparatus and the operation information about the image forming apparatus via the communication processing unit 401. The operation information about the image forming apparatus includes the status of consumables, error information, and information about the apparatus utilization environment information. The device management unit 402 transmits information to the management apparatus 102 in response to a request from the management apparatus 102.

As programs of the above-described processing, the communication processing unit 401, the device management unit 402, the operation information management unit 403, and the setting processing unit 404 are stored on the ROM 203 and the storage device 204 (FIG. 2) as programs. The program is loaded and executed by the CPU 201 on the RAM 202. In executing the program, the CPU 201 writes and reads information on and from the ROM 203 and the storage device 204.

As described above, in the present exemplary embodiment, the processing units 401 through 404 are implemented by the CPU 201 by loading and executing the programs from the ROM 203 or the storage device 204 on the RAM 202. However, alternatively, a part of or the entire processing corresponding to the programs can be implemented by hardware.

FIG. 5 is a block diagram illustrating exemplary processing modules included in the management apparatus 102. Referring to FIG. 5, the management apparatus 102 includes processing modules (units) 501 through 504. Since an information processing apparatus, such as a PC or a server, is often used as the management apparatus 102, the processing units 501 through 504 can be easily implemented by programs.

During data communication between the management apparatus 102 and the image forming apparatus 101 via the network 104, the communication processing unit 501 controls the NW I/F 305 of the management apparatus 102. The communication processing unit 501 transmits and receives data to and from the image forming apparatus 101, which is a monitoring target apparatus, according to an instruction from the management system processing unit 502, which controls the operation of the entire management apparatus 102.

The communication processing unit 501 includes a function for processing a communication protocol. In collecting various information and receiving a notification from the image forming apparatus, the communication processing unit 501 can execute a communication by a protocol provided on the image forming apparatus, such as SMTP or HTTP.

The management system processing unit 502 operates in cooperation with the operation information management unit 503, which manages operation information notified from the image forming apparatus 101. The operation information includes consumable information, error information, and apparatus utilization environment information. In addition, the management system processing unit 502 cooperates with the setting processing unit 504, which executes various system settings and sets information for managing the consumables.

Furthermore, the management system processing unit 502 operates in cooperation with the storage area, such as the RAM 302, the ROM 303, or the storage device 304, to process and manage the information set by the setting processing unit 504 and information about the inventory of consumables used on the monitoring target image forming apparatus.

The setting processing unit 504 can register and update setting information and display the status (content) of the setting via the management system processing unit 502 and the I/O I/F 307 by utilizing the I/O device 308, such as a display, a keyboard, or a mouse. More specifically, the setting processing unit 504 can display a setting screen (not illustrated) on the I/O device 308, via which management information about the monitoring target image forming apparatus, such as a serial number (S/N), a product name, a customer name, an installation location, an administrator, and a description of and about of the monitoring target image forming apparatus, and register the set management information to the storage device 304 as registered information.

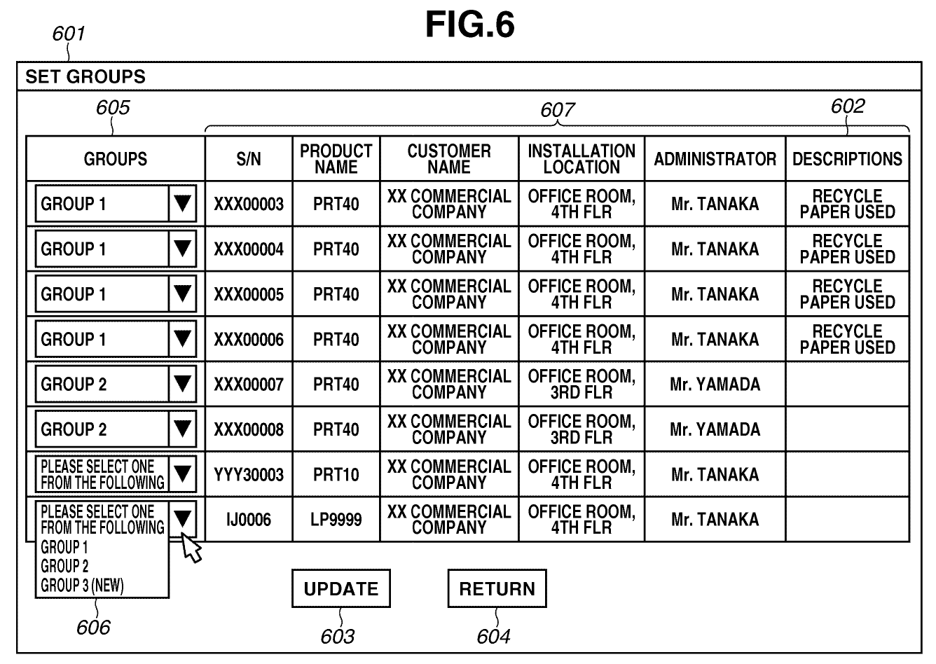

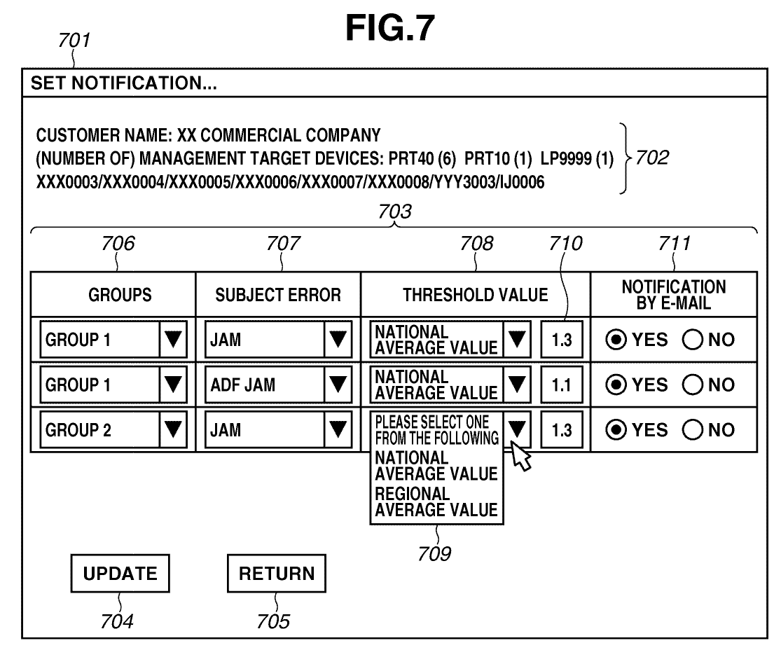

In addition, the setting processing unit 504 displays a group setting screen 601 (FIG. 6) on the I/O device 308. The setting processing unit 504 allows the user to set a group of monitoring target image forming apparatuses registered in the above-described manner and register the group of image forming apparatuses to the storage device 304 via the group setting screen 601. Furthermore, the setting processing unit 504 displays a notification setting screen 701 (FIG. 7) on the I/O device 308. The setting processing unit 504 allows the user to set a setting of an e-mail notification (monitoring level setting) to each registered group and register the setting to the storage device 304 via the notification setting screen 701.

As described above, in the present exemplary embodiment, the processing units 501 through 504 are implemented by the CPU 301 by loading and executing programs from the ROM 303 or the storage device 304 on the RAM 302. However, alternatively, a part of or the entire processing corresponding to the programs can be implemented by hardware.

The group setting screen, which allows the user to set a group of monitoring target image forming apparatuses, will be described in detail below with reference to FIG. 6.

Referring to FIG. 6, the group setting screen 601 is displayed by the setting processing unit 504 on a display of the I/O device 308. Via the group setting screen 601, the user can form a group of a plurality of image forming apparatuses 101, which is managed by the management apparatus 102, in an arbitrary combination. The user can use the keyboard or the mouse of the I/O device 308 to execute a setting via the group setting screen 601.

In setting a group, the user selects an arbitrary group from a selection list 606 included in a group field 605. When the user presses an update button 603, the group setting can be updated. In a non-setting state, the group field 605 displays a text string “Please select one from the following.” When no group has been set, the selection list 606 displays “group 1” in the list as its default display status. When the user selects the “group 1”, the corresponding image forming apparatus is set to the group 1.

After at least one “group 1” is set, the setting processing unit 504 executes control for setting another group. More specifically, in this case, a “group 2” is automatically added to the selection list 606. Similarly, after at least one “group 2” is set, the setting processing unit 504 executes control for setting yet another group. In other words, in this case, a “group 3” is automatically added to the selection list 606. In the present exemplary embodiment, the groups 1, 2, 3, or the like are set. However, the name of each group can be freely input by the user.

Each of fields 607 displays information registered to each image forming apparatus, such as the serial number (S/N), the product name, the customer name, the installation location, the administrator, and the description of and about each image forming apparatus. Additional information, which is input when information about each image forming apparatus is registered, is particularly displayed in the “description” field 602. In the present exemplary embodiment, in order for the user to easily set a group of image forming apparatuses, information about the sheet used in the current processing is displayed in the “description field.

When the user presses a “return” button 604, the screen shifts to another screen according to the setting information set when the user has instructed an “update” button 603 for the last time is set. On the other hand, if the user instructs the return button 604 when the update button 603 has never been instructed via the group setting screen 601, the screen shifts to another screen without changing the setting. Another screen to be displayed in this case will not be described in detail because a description of another screen is not necessary to describe a characteristic of the present invention.

The image forming apparatuses are grouped in the following cases. If a plurality of users output documents on a plurality of image forming apparatuses with a specific tendency, the user may form a group of image forming apparatuses. More specifically, if users belonging to a design department output a document by full color printing, the user may group the image forming apparatuses by using a condition “full color printing”.

Furthermore, the user may group the image forming apparatuses by using a condition such that the image forming apparatus is installed at a site of a division that uses inexpensive sheets or frequently executes and recommends recycle sheet printing (i.e., printing on a blank back side of a sheet that has already been printed by one-sided printing, which can be used as a recycle sheet). In the example illustrated in FIG. 6, the user has grouped the image forming apparatuses under a condition of supplemental information “recycle paper used”, which is displayed in the description field 602.

Alternatively, the user can set a group of image forming apparatuses by using a condition such that the image forming apparatus operates night and day. Further alternatively, the user can group the image forming apparatuses by using a condition of the time of introduction of the image forming apparatuses.

However, if the type of one image forming apparatus is completely different from the type of the others in terms of the configuration thereof, the image forming apparatus having a configuration different from that of the others can be grouped in a group including one image forming apparatus only. More specifically, if the device 9 (FIG. 1) is an inkjet printer, whose configuration is completely different from that of the other devices (i.e., the devices 1 through 8), then the device 9 can be grouped in a group including the device 9 only.

The notification setting screen for setting a notification by e-mail for each group and each error will be described in detail below with reference to FIG. 7.

Referring to FIG. 7, via the notification setting screen 701, the user can set a notification condition (a monitoring level) to each e-mail created for each group and each error, which is a subject of the notification. A setting list 703 includes a group selection field 706, a notification subject error selection field 707, a threshold value setting field 708, and an e-mail notification execution setting field 711. The threshold value setting field 708 includes a reference value (threshold value) selection field 709 and an entry field 710. The user can enter a correction value for correcting the selected reference value via the entry field 710.

In addition, the notification setting screen 701 includes an “update” button 704 and a “return” button 705. The update button 704 can be operated to update a setting value. The return button 705 can be operated to shift to another screen after executing setting or to end the setting without updating the setting. Another screen to be displayed in this case will not be described in detail because a description of another screen is not necessary to describe a characteristic of the present invention.

Although not illustrated in FIG. 7, in a default setting state, only one row is displayed for the setting list 703. The single row displayed for each of the fields 706 through 708 in the default state displays a text string “Please select one from the following.” After a setting value is input to the group selection field 706, the notification subject error selection field 707, the selection field 709, the entry field 710, and the e-mail notification execution setting field 711, and the user presses the update button 704 in this state, a second row is newly and additionally displayed to allow the user to execute another setting. By repeating the setting to the newly displayed row and the updating thereof, another row is additionally displayed.

An exemplary method for executing the notification setting will be described below with reference to FIG. 7, focusing on fields of a third row of the setting list 703. In the group selection field 706, already registered group names are displayed as a list. The user selects a group via the group selection field 706. In addition, the user selects an error to be notified, such as a jam, an ADF jam, or other errors via the notification subject error selection field 707.

In the notification subject error selection field 707, alternatives of errors that can be set as the notification subject error according to the model type of the image forming apparatus are displayed. If an image forming apparatus 101 that cannot detect a jam is included in the group 1 but if any of the other image forming apparatuses included in the same group supports detection of a jam, the alternative “jam” is displayed.

Via the selection field 709 of the threshold value setting field 708, the user selects information about an average value for the notification subject error (reference value information) and inputs a correction value for correcting the threshold value selected via the entry field 710.

In the present exemplary embodiment, as alternatives displayed in the selection field 709, a national average value and a regional average value (i.e., an average value of a region, such as Kanto Region, or an average value of a sales company that performs the aggregate calculation of data) are used. However, instead of the national or regional average value, a worldwide average can be used as an alternative displayed in the selection field 709 for the threshold value if the corresponding product is shipped worldwide. More specifically, the user selects a population used as the reference.

Via the entry field 710, the user enters a correction value, which is determined based on the variation of values to the average value selected via the selection field 709. If a value “1.3” has been entered via the entry field 710 as illustrated in FIG. 7, a value calculated by multiplying the average value selected via the selection field 709 by the correction value 1.3, is used as the threshold value.

If a value smaller than “1.0” is used as the correction value for correcting the reference value, a threshold value smaller than the average value can be set. In other words, the user can adjust the threshold value used for the notification according to the model type of the image forming apparatus and the type of the notification subject error by arbitrarily setting the correction value.

Via the e-mail notification execution setting field 711, the user sets whether to notify, by e-mail, the state of the image forming apparatus if the conditions set via the group selection field 706, the notification subject error selection field 707, and the threshold value setting field 708 are satisfied. If the state satisfying the conditions set via the fields 706 through 708 is to be notified by e-mail, the user selects “Yes” for the e-mail notification execution setting field 711. On the other hand, if the e-mail notification is not to be executed even if the state of the image forming apparatus satisfies the conditions set via the fields 706 through 708, the user sets “No” via the e-mail notification execution setting field 711. The above-described setting content is updated when the user presses the update button 704 as described above.

An e-mail address of a destination of notification executed when “Yes” has been selected by the user via the e-mail notification execution setting field 711 is previously registered via another screen (not illustrated) or by the system and stored on the storage device 304. However, the present exemplary embodiment is not limited to this. More specifically, an e-mail address of the notification destination can be set via an e-mail address setting field, which is provided on the notification setting screen.

Processing for analyzing an error occurring on and an installation environment of a group of image forming apparatuses and processing for determining whether to execute a notification according to an exemplary embodiment of the present invention will be described in detail below.

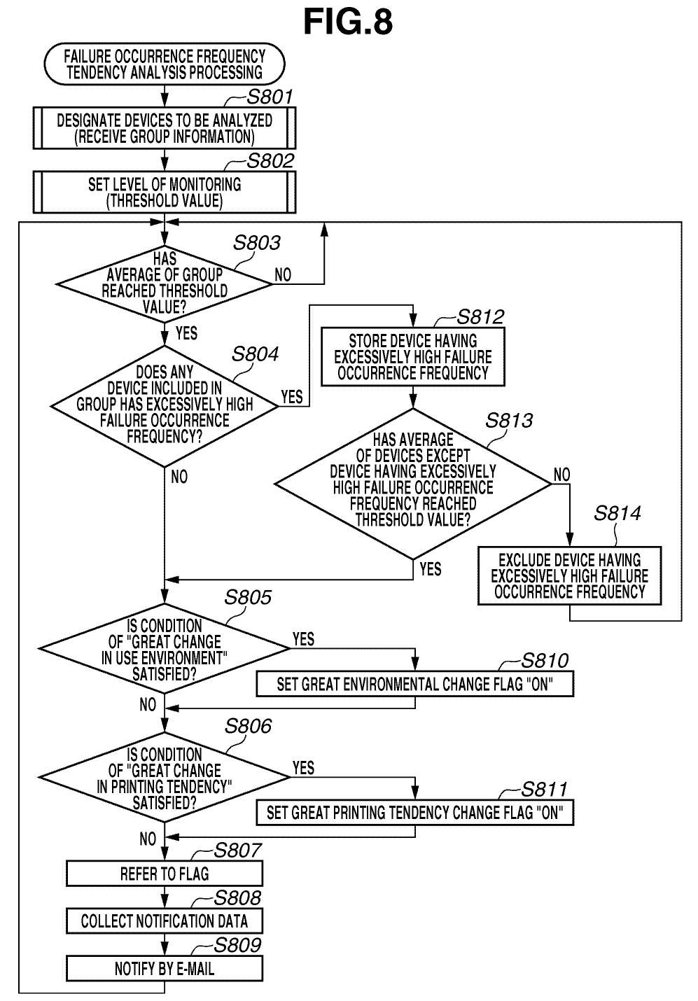

FIG. 8 is a flow chart illustrating an exemplary flow of processing for executing an analysis on a plurality of grouped image forming apparatuses according to an exemplary embodiment of the present invention. Processing in each step of the flow chart of FIG. 8 is executed by each processing unit of the management apparatus 102 described above with reference to FIG. 5. More specifically, a program for the processing in each step of the flow chart of FIG. 8 is stored on either one of the RAM 302, the ROM 303, and the storage device 304 of the management apparatus 102 and executed by the CPU 301.

In addition, group information set by the user, notification setting information, and status information notified from the image forming apparatus 101 are recorded on the storage device 304 to prevent loss thereof even after the management apparatus 102 is powered off.

The processing illustrated in FIG. 8 is independently executed in the unit of the e-mail notification setting described above with reference to FIG. 7. More specifically, if an error and a jam have mixedly occurred at the same time, the determination is executed separately for each of the error and jam. In the present exemplary embodiment, it is supposed that a paper jam (hereinafter simply referred to as a “jam”) has frequently occurred on the image forming apparatus.

Referring to FIG. 8, in step S801, the setting processing unit 404 receives a designation of an analysis target device (the group information), and stores the received group information on the storage device 304. In the present exemplary embodiment, the processing is executed in the unit of a group of image forming apparatuses, which is arbitrarily grouped as described above with reference to FIG. 6. If the group includes one image forming apparatus only, the image forming apparatus only is set as a monitoring target device.

In step S802, the setting processing unit 404 receives a setting of the monitoring level, and stores the received setting of the monitoring level on the storage device 304. As described above with reference to FIG. 7, the monitoring level including the monitoring target group, the notification subject error, and the threshold value is set.

After the setting in steps S801 and S802 is completed, the management system processing unit 502 repeats the monitoring and the analysis in step S803 and the subsequent steps. If the management apparatus 102 is booted after the setting in steps S801 and S802 are completed, the management apparatus 102 executes the processing in steps S803 and the subsequent steps.

In step S803, the management system processing unit 502 analyzes the frequency of occurrence of the subject error that has occurred on a plurality of the image forming apparatuses included in the monitoring target group. In step S803, the management system processing unit 502 determines whether the average value of the frequency of occurrence of the subject error occurring in the group has reached the threshold value set by the user. Furthermore, the management system processing unit 502 collects information about whether a failure, such as a jam or an error, has occurred on the image forming apparatus included in the monitoring target group, which is notified by the image forming apparatus.

In addition, the management system processing unit 502 periodically collects apparatus utilization environment information (counter information and the temperature and the humidity of the image forming apparatus) regardless of whether an error has occurred on the image forming apparatus included in the monitoring target group.

More specifically, in step S803, the management system processing unit 502 analyzes the frequency of occurrence of the monitoring subject error based on the collected information (error information about an error that has occurred on the image forming apparatus and counter information) for each image forming apparatus included in the monitoring target group. In addition, the management system processing unit 502 calculates an average of the calculated values of frequency of occurrence of the error for each image forming apparatus. Based on the average of the calculated values of frequency of occurrence of the error occurring on the image forming apparatuses included in the group, the management system processing unit 502 analyzes an average of the group.

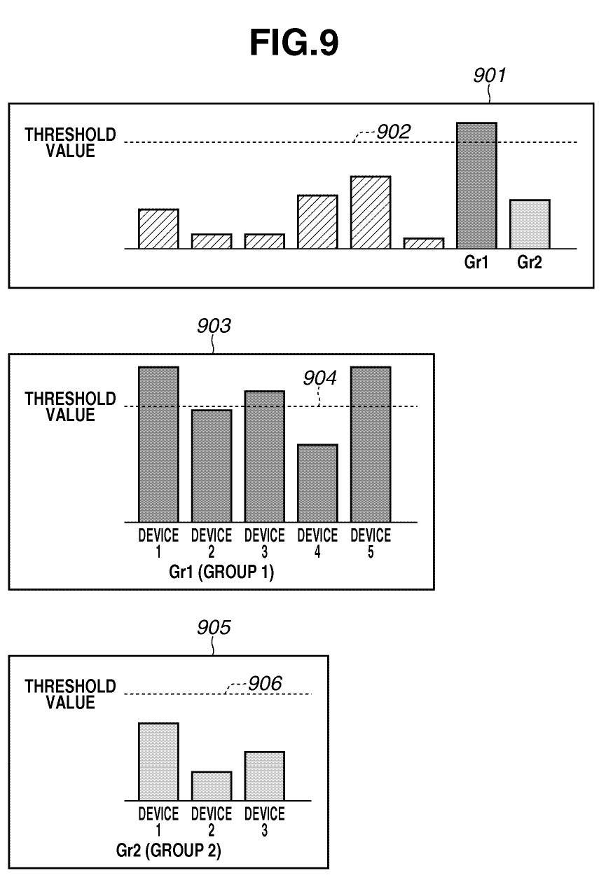

If it is determined that the average of the frequency of occurrence of the monitoring subject error in the group has not reached the threshold value (NO in step S803), then the management system processing unit 502 repeats the processing in step S803 at an arbitrary timing. On the other hand, if it is determined that the average of the frequency of occurrence of the monitoring subject error in the group has reached the threshold value (YES in step S803), then the processing proceeds to step S804. The analysis in step S803 will be described in more detail below with reference to FIG. 9.

FIG. 9 illustrates an example of a case where the frequency of occurrence of an error has exceeded the monitoring level setting. Referring to FIG. 9, a graph 901 illustrates an example of an average of the frequency of occurrence of a jam of a group within the predetermined time period. In the graph 901, the group average of the frequency of occurrence the jam of the group 1 (“Gr1”) has exceeded a threshold value 902. On the other hand, the group average of the frequency of occurrence the jam of the group 2 (“Gr2”) is below the threshold value 902.

A graph 903 illustrates an example of the frequency of occurrence of a jam in the unit of a device included in the group 1 (Gr1). In the graph 903, the frequency of occurrence of a jam of each of the devices 1, 3, and 5 has exceeded a threshold value 904. On the other hand, the frequency of occurrence of a jam of each of the devices 2 and 4 is below the threshold value 904.

A graph 905 illustrates an example of the frequency of occurrence of a jam of each of the devices 1 through 3 included in the group 2 (“Gr2”). In the graph 905, the frequency of occurrence of a jam of all the devices 1 through 3 is below a threshold value 906.

If the group 2 (“Gr2”) has been set as the monitoring target group and if a jam has been set as the monitoring subject error, then in step S803 (FIG. 8), the management system processing unit 502 determines that the group average of the frequency of occurrence of a jam has not reached the threshold value. In this case, the management system processing unit 502 repeats the processing in step S803.

On the other hand, if the group 1 (“Gr1”) has been set as the monitoring target group and if a jam has been set as the monitoring subject error, then in step S803 (FIG. 8), the management system processing unit 502 determines that the group average of the frequency of occurrence of a jam has reached the threshold value. In this case, the processing proceeds to step S804.

Returning to the description of the flow chart of FIG. 8, in step S804, the management system processing unit 502 determines whether any image forming apparatus exists having an excessively high frequency of occurrence of a monitoring subject error compared to the other image forming apparatuses included in the monitoring target group (error determination). If it is determined that any image forming apparatus exists having an excessively high frequency of occurrence of a monitoring subject error (YES in step S804), then the processing proceeds to step S812. In step S812, the management system processing unit 502 stores management information for identifying the image forming apparatus having the excessively high frequency of occurrence of the monitoring subject error on the storage device 304. Then the processing proceeds to step S813.

The “image forming apparatus having an excessively high frequency of occurrence of a monitoring subject error” refers to the following image forming apparatus. For example, an image forming apparatus having a frequency of occurrence of a monitoring subject error higher than a total frequency thereof including values of frequency thereof on the other image forming apparatus included in the group, is referred to as the image forming apparatus having an excessively high frequency of occurrence of a monitoring subject error. Furthermore, an image forming apparatus having a frequency of occurrence of a monitoring subject error higher than double the frequency of occurrence of a monitoring subject error of another image forming apparatus having the second highest frequency thereof within the group is also referred to as the image forming apparatus having an excessively high frequency of occurrence of a monitoring subject error. However, it can be determined by a condition other than the above-described conditions.

In step S813, the management system processing unit 502 determines whether the group average of the frequency of occurrence of the monitoring subject error calculated by excluding the image forming apparatus having the excessively high frequency of occurrence thereof exceeds the threshold value. If it is determined that the group average of the frequency of occurrence of the monitoring subject error calculated by excluding the image forming apparatus having the excessively high frequency thereof does not exceed the threshold value (NO in step S813), the management system processing unit 502 determines that the group average of the frequency of occurrence of the monitoring subject error has exceeded the threshold value primarily due to the affect from the image forming apparatus having the excessively high frequency thereof.

In step S814, the management system processing unit 502 executes control for excluding the image forming apparatus having the excessively high monitoring subject error occurrence frequency from the image forming apparatuses whose frequency of occurrence of the monitoring subject error is to be used as the basis of the determination in step S803. Then the processing returns to step S803. In this case, in step S803, the processing is continued without using the image forming apparatus having the excessively high monitoring subject error occurrence frequency in the determination.

On the other hand, if it is determined that the group average of the frequency of occurrence of the monitoring subject error has exceeded the threshold value even if the image forming apparatus having the excessively high monitoring subject error occurrence frequency is not used in the determination (YES in step S813), then the processing proceeds to step S805.

In the processing in steps S803, S804, and S812 through S814, the frequency of occurrence of the monitoring subject error within a predetermined time period is used. However, the number of monitoring subject errors that have occurred within a predetermined time period can be used instead.

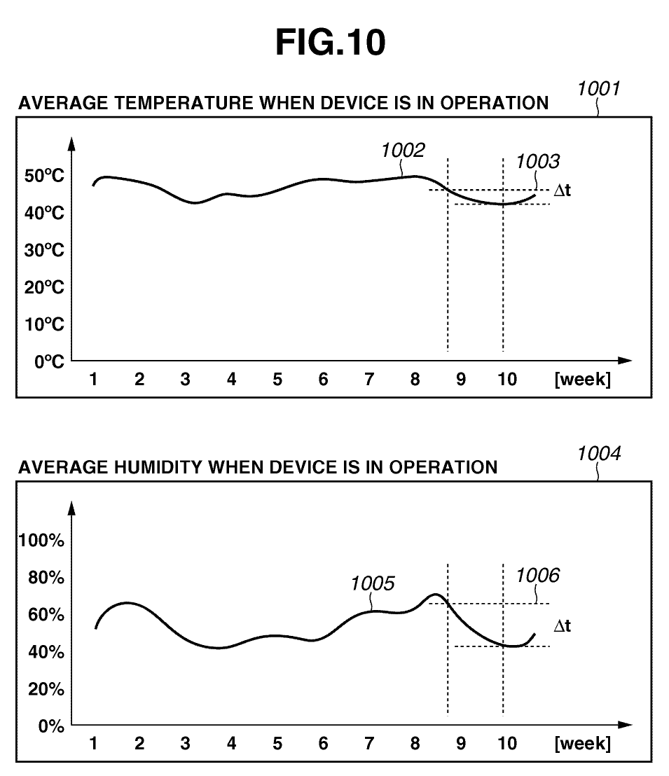

In step S805, the management system processing unit 502 determines whether a condition of great variation in the apparatus utilization environment of the monitoring target group has been satisfied (environmental determination). The “variation in the apparatus utilization environment” refers to a group average of the amount of variation of the environment, in which the image forming apparatus included in the monitoring target group operates, particularly in terms of the temperature and the humidity of the environment or the group average of the amount of variation of the tendency of printing. The variation of the apparatus utilization environment will be described in detail below with reference to FIG. 10.

FIG. 10 is a graph indicating an average of information about the temperature and the humidity of a specific image forming apparatus included in a monitoring target image forming apparatus group collected therefrom. The temperature and the humidity measured on the image forming apparatus may vary when printing is executed thereon or when the operation mode of the image forming apparatus has shifted to a power saving mode. Accordingly, the present exemplary embodiment uses an average of measured values.

Referring to FIG. 10, a temperature average graph 1001 includes a temperature average 1002. A temperature difference (Δt) 1003 indicates a difference between highest and lowest average temperatures (° C.) within a time period from an eighth week to a ninth week. In addition, a humidity average graph 1004 includes a humidity average 1005. A humidity difference (Δh) 1006 indicates a difference between highest and lowest average humidity (° C.) within a time period from an eighth week to a ninth week.

When that a monitoring subject error (a jam, for example) has very frequently occurred within the time period from the eighth week to the ninth week and the group average has exceeded the threshold value, the management system processing unit 502 executes the processing in step S805 (FIG. 8). Furthermore, in this case, if the difference between the group average of the temperature difference (Δt) 1003 for the weeks (the time period from the eighth week to the ninth week) and that for the other weeks is not great (i.e., if the difference is equal to or less than a specific value), then the management system processing unit 502 determines that the temperature environment has not greatly varied.

In other words, in this case, the management system processing unit 502 determines that the condition of great temperature variation is not satisfied. On the other hand, if the difference between the group average of the temperature difference (Δt) 1003 for the weeks (the time period from the eighth week to the ninth week) and that for the other weeks is great (i.e., if the difference is greater than a specific value), then the management system processing unit 502 determines that the condition of great variation in the temperature environment is satisfied.

With respect to the humidity, similarly, if the difference between the group average of the humidity difference (Δh) 1006 for the weeks (the time period from the eighth week to the ninth week) and that for the other weeks is not great (i.e., if the difference is equal to or less than the specific value), then the management system processing unit 502 determines that the humidity environment has not greatly varied.

In other words, in this case, the management system processing unit 502 determines that the condition of great humidity variation is not satisfied. On the other hand, if the difference between the group average of the humidity difference (Δh) 1006 for the weeks (the time period from the eighth week to the ninth week) and that for the other weeks is great (i.e., if the difference is greater than the specific value), then the management system processing unit 502 determines that the condition of great variation in the humidity environment is satisfied.

If it is determined that neither the condition of great temperature variation nor the condition of great humidity variation is satisfied (NO in step S805), then the management system processing unit 502 determines that the condition of the great environmental variation is not satisfied. Then the processing proceeds to step S806.

On the other hand, if it is determined that either the condition of great temperature variation or the condition of great humidity variation is satisfied (YES in step S805), then the management system processing unit 502 determines that the condition of the great environmental variation is satisfied. Then the processing proceeds to step S810. In step S810, the management system processing unit 502 sets a great environmental variation flag for each group, which is stored on the storage device 304, to be “ON”. Then the processing proceeds to step S806.

In step S805, the management system processing unit 502 compares the group average of the temperature (humidity) difference within a predetermined time period and the group average of the temperature (humidity) difference within the other time periods, and determines whether the condition of great temperature (humidity) environment variation is satisfied based on the result of the comparison. However, the present exemplary embodiment is not limited to this. More specifically, whether the condition of great temperature (humidity) environment variation is satisfied can be determined as a result of comparison between a group average of the temperature (humidity) difference within a predetermined time period and a predetermined temperature (predetermined humidity).

In step S806, the management system processing unit 502 determines whether a condition of a great variation in the printing tendency of the monitoring target group has been satisfied (environmental determination). The variation in the printing tendency refers to an increase or decrease of the number of prints printed by the image forming apparatus included in the monitoring target group or the variation in the tendency of a print setting set to the image forming apparatus included in the monitoring target group.

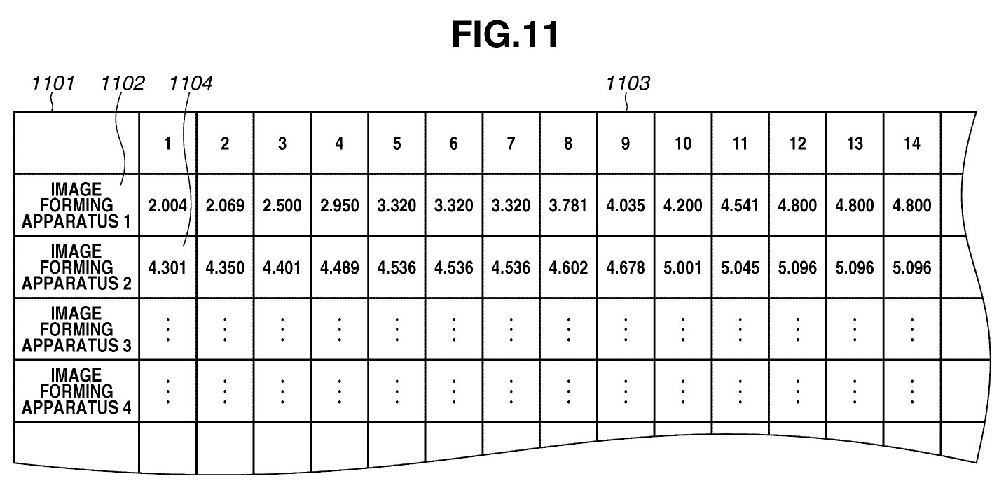

The increase or decrease of the number of prints can be determined for a specific paper size instead of determining that simply based on the increase or decrease of the total number of printed sheets. In addition, the variation in the tendency of a print setting set to the image forming apparatus refers to how often the setting of processing, such as two-sided printing, finishing, and saddle stitch binding, is utilized (set to the image forming apparatus). The variation in the printing tendency will be described in detail below with reference to FIG. 11.

FIG. 11 is a table storing the sum total of the number of prints collected from the image forming apparatus. For the number of prints, the total of the number of prints can be used without individually summing up the number of prints for each paper size. Alternatively, the total number of prints can be summed up for each paper size sheet, such as an A4-size sheet or B4-size sheet. Furthermore, the printing tendency can be determined based on the tendency of finishing, such as two-sided printing or saddle stitch binding (i.e., the ratio of print operations executed by two-sided printing or saddle stitch binding), as well as based on the number of prints.

Referring to FIG. 11, a table 1101 stores a result of compiling the number of prints. The table 1101 includes a compilation result 1102 compiled for each image forming apparatus. In the example illustrated in FIG. 11, the number of prints is compiled in the unit of a week. A column 1103 stores a result of compiling the number of prints executed in the ninth week. In the example illustrated in FIG. 11, the number of prints is compiled in the unit of the week used in calculating the temperature difference and the humidity difference described above. However, if the temperature difference and the humidity difference are calculated in the unit of a day, a plurality of predetermined days, or a month, the number of prints is compiled in the same unit.

More specifically, a result of the first week includes the number of prints compiled within a time period from the start of the utilization of the apparatus to a seventh day from the start of the utilization of the apparatus. In the example illustrated in FIG. 11, as indicated by a field 1104, the sum total of the number of prints printed by an image forming apparatus 2 for the first week is “4,301” sheets. A result of an n-th week includes the number of prints compiled within a time period from the start of the utilization of the apparatus to an n-th week from the start of the utilization of the apparatus. In the example illustrated in FIG. 11, as indicated by a field 1103, the sum total of the number of prints printed by an image forming apparatus 2 for the ninth week is “4,678” sheets.

When a monitoring subject error (a jam, for example) has very frequently occurred within the time period from the eighth week to the ninth week and the group average has exceeded the threshold value, the management system processing unit 502 executes the processing in step S806 (FIG. 8). In this case, the management system processing unit 502 verifies the number of prints printed within the time period from the eighth week to the ninth week (corresponding to the column 1104 for the ninth week illustrated in FIG. 11). If the difference between the group average of the increased quantity of the sum total of the number of prints printed within the weeks (i.e., the time period from the eighth week to the ninth week) and the group average of the increased quantity of the sum total of the number of prints printed within the other weeks is not great (i.e., if the difference is equal to or below a specific value), then the management system processing unit 502 determines that the printing tendency has not greatly varied. In other words, the management system processing unit 502 determines that the condition of great printing tendency variation is not satisfied.

On the other hand, if the difference between the group average of the increased quantity of the sum total of the number of prints printed within the weeks (i.e., the time period from the eighth week to the ninth week) and the group average of the increased quantity of the sum total of the number of prints printed within the other weeks is great (i.e., if the difference is greater than the specific value), then the management system processing unit 502 determines that the printing tendency has greatly varied. In other words, the management system processing unit 502 determines that the condition of great printing tendency variation is satisfied.

Returning to the description of the processing in the flow chart of FIG. 8, if it is determined that the condition of the great printing tendency variation in the monitoring target group has been satisfied (YES in step S806), then the processing proceeds to step S811. In step S811, the management system processing unit 502 sets a great printing tendency variation flag for each group stored on storage device 304 to be “ON”. Then the processing proceeds to step S807.

On the other hand, if it is determined that the condition of the great printing tendency variation in the monitoring target group has not been satisfied (NO in step S806), then the processing proceeds directly to step 807.

In step S806, the management system processing unit 502 compares the group average of the increase in the sum total of the number of prints printed within a predetermined time period with the group average of the increase in the sum total of the number of prints printed within the other time periods, and determines whether the condition of great printing tendency variation is satisfied. However, whether the condition of great printing tendency variation can be determined based on a result of comparison between the group average of the increase in the sum total of the number of prints printed within a predetermined time period and a predetermined number of printed sheets.

In step S807, the management system processing unit 502 refers to the flag to verify the results of the determination in steps S805 and S806. In step S808, the management system processing unit 502 collects data for executing the notification according to the information acquired by referring to the two flags in step S807 to provide a service to the group of image forming apparatuses having a high frequency of occurrence of the monitoring subject error. The data for the notification includes various information, such as information about a customer to whom the service is to be provided, management information about the image forming apparatus, a record of the previous maintenance of the corresponding apparatus, and a content of the notification to a person in charge of the maintenance.

The content of the notification to the person in charge of the maintenance will be described in detail below. The content of the notification is determined according to the state (ON/OFF) of the great environmental variation flag and the great printing tendency variation flag for the monitoring target group. More specifically, if information indicated by both flags is “ON” or information indicated by either one of the flags is “ON”, a content, such as “the frequency of occurrence of the error has become high presumably due to the installation environment and/or the tendency of utilization of the image forming apparatus has greatly varied within a specific time period” may be notified to the person in charge of maintenance.

On the other hand, if the information indicated by the both flags is “OFF”, it is indicated that neither the installation environment of nor the tendency of printing executed by the image forming apparatus has not greatly varied. However, in this case, if the frequency of occurrence of the monitoring subject error is high for the entire group including the other image forming apparatuses installed in the similar installation location, the monitoring subject error has frequently occurred in the group due to the following causes. More specifically, in this case, the image forming apparatuses installed in the environment of the customer may have been operated by using a special sheet, which is not appropriate for the image forming apparatuses.

In order to correct the above-described error, a service is to be provided to the customer such that the person in charge of maintenance recommends the customer to use an appropriate sheet, that the period of providing a periodical maintenance service agreed by a contract with the customer is revised to a shorter period, or that the person in charge of maintenance or other appropriate person asks the customer to consult with them for an appropriate operation of the image forming apparatus. Accordingly, the content of the notification, such as “The frequent occurrence of the error has been detected. Please provide a maintenance service.” is notified in this case.

Furthermore, in order for the service person to quickly provide an appropriate service to the customer, the content of the notification including supplemental information, such as “The installation environment of the image forming apparatus used by the customer and the tendency of printing by the image forming apparatus have not greatly varied. Accordingly, the error is likely to have occurred due to the operation executed by the customer.” (i.e., the error has occurred presumably due to a cause other than the apparatus utilization environment), can be included. In addition, a specific instruction for changing the content of the service provided by the customer, such that “Please shorten the period of the periodical maintenance.”, can be included in the notification.

The correspondence relationship between the information indicated by the flag and the content to be notified can be previously set and stored on the storage device 304. Alternatively, the correspondence relationship between the flag information and the notification content can be arbitrarily changed by an administrator of the system before actually notifying the notification to the person in charge of maintenance.

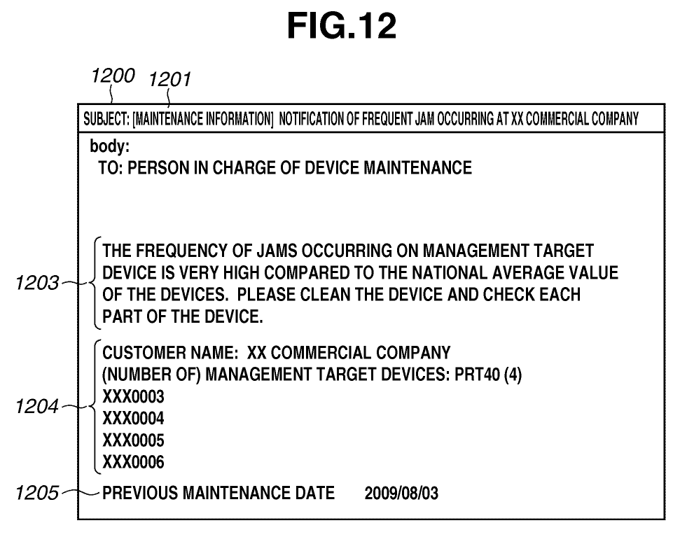

In step S809, the management system processing unit 502 creates an e-mail based on the data collected in step S808 and executes the notification by e-mail (FIG. 12). Then the processing returns to step S803 and continues the monitoring.

FIG. 12 illustrates an example of an e-mail notified in step S809 of FIG. 8. Referring to FIG. 12, e-mail data 1200 includes a mail subject 1201, which describes the outline of the e-mail to be notified. More specifically, the management system processing unit 502 generates the subject 1201 based on the customer name (in the example illustrated in FIG. 12, “XX Commercial Company”), which is included in the registered information 607 about the monitoring target group and based on the name of the monitoring subject error (in the example illustrated in FIG. 12, “jam”).

In addition, the e-mail data 1200 includes an e-mail body 1202. The management system processing unit 502 inserts a message 1203 into the e-mail body 1202, which notifies the person in charge of maintenance that the monitoring subject error (in the example illustrated in FIG. 12, “jam”) has frequently occurred and prompts the person in charge of maintenance to execute checking of the image forming apparatus. As described above, supplemental information describing the presumable cause of the error, such as the variation in the installation environment or the printing tendency, can be included in the e-mail body 1202.

The management system processing unit 502 inserts management information 1204 (in the example illustrated in FIG. 12, the customer name, the product name, and the S/N) about the image forming apparatus included in the monitoring target group into the e-mail body 1202. In addition, the management system processing unit 502 inserts a record 1205 (not illustrated) of the previous maintenance executed for the monitoring target group to the e-mail body 1202.

Although not illustrated in the drawing, it is supposed that the monitoring target group maintenance record 1205 of each group has been previously stored on the storage device 304. The monitoring target group maintenance record 1205 can be input by the service person who actually executes the instructed maintenance.

In the present exemplary embodiment, in steps S803, S804, and S812 through S814, the group average of the frequency of occurrence of the monitoring subject error is used. Furthermore, in steps S805 and S806, the group average of the temperature (the humidity) or the group average corresponding to the increased quantity of the sum total of the number of prints is used, respectively. However, a result of statistics other than averaging (i.e., a statistic value other than the average value) can be used instead. More specifically, a median, the maximum (highest) value, the minimum (lowest) value, or an average value calculated based on values except for the maximum (highest) and minimum (lowest) values of the image forming apparatuses included in the group can be used. In other words, any result of statistics (any statistic value) based on which the tendency of utilization of the image forming apparatus included in the group can be used in the processing in steps S803, S804, S812 through S814, and S805 and S806.

The present invention can be implemented by the above-described embodiment. However, it is not necessary that the management apparatus 102 exists on the Internet. More specifically, the management apparatus 102 can exist within a local area network (LAN) installed to a customer's site.

As described above, in step S806 (FIG. 8), the management system processing unit 502 determines whether the condition of great environmental variation is satisfied by using the amount of variation of the temperature (the humidity) as a parameter for the environmental variation. However, the determination in step S806 (FIG. 8) as to whether the condition of great environmental variation has been satisfied based on an environmental variation including or determined based on variation of a value of the voltage supplied to the image forming apparatus.

As described above, in order to provide an appropriate maintenance service according to the apparatus utilization environment, the present exemplary embodiment monitors a group including a plurality of image forming apparatuses instead of merely monitoring each image forming apparatus. In addition, the present exemplary embodiment executes the analysis, determination, and notification based on a result of analysis of a cause of an error, particularly based on the environmental information and the information about the printing tendency. More specifically, the present exemplary embodiment analyzes the status of the currently occurring error based on the operation information collected from a plurality of the image forming apparatuses included in a group, which is collected therefrom.

By executing the above-described analysis, the present exemplary embodiment can identify the cause of the detected error, as to whether the error has occurred due to a cause uniquely arising on the image forming apparatus, whether the error has occurred due to a cause dependent on the installation environment of the image forming apparatus, and whether the error has occurred due to the type of frequently executed operation on the image forming apparatus, including the type of the sheet used on the image forming apparatus. Accordingly, the present exemplary embodiment is capable of identifying an image forming apparatus on which a jam has frequently occurred due to the type of the sheet used thereon, i.e., an image forming apparatus which has been likely to be operated by an inappropriate method, and is also capable of executing a notification having a content such that a jam has very frequently occurred in a current operation environment of the identified image forming apparatus. Furthermore, the present exemplary embodiment having the above-described configuration is capable of providing an appropriate service, such as a quick periodical maintenance, customer's detailed counsel with the person in charge of maintenance for an appropriate operation method of the image forming apparatus, or an optimal revision of the agreement agreed by the corresponding maintenance service agreement.

In the above-described notification, the management system processing unit 502 sends the e-mail to the address set to each group. However, alternatively, the notification of all the groups can be notified to the same e-mail address (i.e., an e-mail address of an administrator of the management apparatus 102, for example). In addition, the present invention can also be implemented if the content of the above-described notification is previously stored in a predetermined storage area, and the administrator of the management apparatus 102 is enabled to view and verify the notification after logging into the management apparatus 102. Furthermore, the present exemplary embodiment can also be implemented if the content of the above-described notification is at first transmitted to each image forming apparatus included in the group and the content of the received notification is displayed on an operation unit of each image forming apparatus.

The present invention can also be realized by executing the following process. That is, a process in which a software (program) that realizes the functions of the above-described embodiments is supplied to the system or apparatus via a network or a recording medium of various types, and then a computer of the system or apparatus (or devices such as CPU or MPU) reads out the program and executes it. In such a case, the recording medium where the program is stored as well as the program are included in the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-002795 filed Jan. 8, 2010, which is hereby incorporated by reference herein in its entirety.

What is claimed is:

1. An apparatus comprising:
a collection unit configured to collect, from a plurality of image forming apparatuses, information about a status of occurrence of an error occurring on the plurality of image forming apparatuses and an utilization environment in which the plurality of image forming apparatuses is utilized;
an error determination unit configured to determine whether an error has frequently occurred on the plurality of image forming apparatuses within a predetermined time period based on the collected information about the status of occurrence of the error;
an environment determination unit configured to determine whether a variation satisfying a predetermined condition has occurred to the utilization environment of the plurality of image forming apparatuses based on the collected information about the utilization environment; and
a control unit configured, if an error has frequently occurred and the utilization environment has varied, to execute control for notifying information indicating that the error has frequently occurred together with information about the varied utilization environment,
wherein the control unit is configured, if the error has frequently occurred and the utilization environment has not varied, to notify information indicating that the error has occurred together with the information about the utilization environment.

2. The apparatus according to claim 1, further comprising:
a grouping unit configured to group the plurality of image forming apparatuses into a plurality of groups,
wherein the error determination unit is configured to calculate a first statistic value by processing the information about the occurrence of the error for each group, and configured to determine whether the error has frequently occurred for each group based on the calculated first statistic value,
wherein the environmental determination unit is configured to calculate a second statistic value by processing the information about the utilization environment for each group, and configured to determine whether the utilization environment has varied for each group based on the calculated second statistic value, and
wherein the control unit is configured to execute control for notifying information indicating that the error has occurred in the group together with supplemental information about the utilization environment according to a result of the determination by the environmental determination unit.

3. The apparatus according to claim 2, wherein the control unit is configured to notify the information to a notification destination previously set to each group.

4. The apparatus according to claim 2, wherein the error determination unit is configured, if the first statistic value indicating a frequency of occurrence of an error that has occurred on each image forming apparatus included in the group within a predetermined time period is greater than a threshold value, to determine that the error has frequently occurred in the group within the time period.

5. The apparatus according to claim 4, further comprising a setting unit configured to set the threshold value to each group.

6. The apparatus according to claim 1, wherein the information about the utilization environment includes at least one of a temperature inside or around each image forming apparatus, a humidity inside or around each image forming apparatus, and a number of prints printed by each image forming apparatus.

7. The apparatus according to claim 2,
wherein the information about the utilization environment includes at least either one of the temperature inside or around each image forming apparatus, the humidity inside or around each image forming apparatus, and a number of prints printed by each image forming apparatus, and
wherein the environmental determination unit is, if none of conditions is satisfied, such that the second statistic value of an amount of variation of the temperature of each image forming apparatus included in the group within a predetermined time period is higher than a predetermined temperature, that the second statistic value of an amount of variation of the humidity of each image forming apparatus included in the group within the predetermined time period is higher than a predetermined humidity, or that the second statistic value of an amount of variation of a number of prints printed by each image forming apparatus included in the group within the predetermined time period is greater than a predetermined number of prints, configured to determine that the utilization environment of the group has not varied.

8. The apparatus according to claim 7,
wherein the predetermined temperature is the second statistic value of the amount of variation of the temperature of each image forming apparatus included in the group within a time period different from the predetermined time period,
wherein the predetermined humidity is the second statistic value of the amount of variation of the humidity of each image forming apparatus included in the group within a time period different from the predetermined time period, and
wherein the predetermined number of prints is the second statistic value of the amount of variation of the number of prints printed by each image forming apparatus included in the group within a time period different from the predetermined time period.

9. The apparatus according to claim 2, wherein the error determination unit is configured to exclude a forming apparatus having excessively high error occurrence frequency from image forming apparatuses included in the group to execute the determination.

10. An apparatus comprising:
a collection unit configured to collect, from a plurality of image forming apparatuses, information about a status of occurrence of an error occurring on the plurality of image forming apparatuses and an utilization environment in which the plurality of image forming apparatuses is utilized;
an error determination unit configured to determine whether an error has frequently occurred on the plurality of image forming apparatuses within a predetermined time period based on the collected information about the status of occurrence of the error;
an environment determination unit configured to determine whether a variation satisfying a predetermined condition has occurred to the utilization environment of the plurality of image forming apparatuses based on the collected information about the utilization environment; and
a control unit configured, if the error has frequently occurred and the utilization environment has not varied, to notify information indicating that the error has occurred together with information indicating that the error has occurred due to a cause different from the utilization environment.

11. The apparatus according to claim 10, further comprising:
a grouping unit configured to group the plurality of image forming apparatuses into a plurality of groups,
wherein the error determination unit is configured to calculate a first statistic value by processing the information about the occurrence of the error for each group, and configured to determine whether the error has frequently occurred for each group based on the calculated first statistic value,
wherein the environmental determination unit is configured to calculate a second statistic value by processing the information about the utilization environment for each group, and configured to determine whether the utilization environment has varied for each group based on the calculated second statistic value, and
wherein the control unit is configured to execute control for notifying information indicating that the error has occurred in the group together with supplemental information about the utilization environment according to a result of the determination by the environmental determination unit.

12. The apparatus according to claim 10, wherein the information about the utilization environment includes at least one of a temperature inside or around each image forming apparatus, a humidity inside or around each image forming apparatus, and a number of prints printed by each image forming apparatus.

13. A method executed by an apparatus, the method comprising:
collecting, from the plurality of image forming apparatuses, information about a status of occurrence of an error occurring on the plurality of image forming apparatuses and an utilization environment in which the plurality of image forming apparatuses is utilized;
executing an error determination for determining whether an error has frequently occurred on the plurality of forming apparatuses within a predetermined time period based on the collected information about the status of occurrence;
executing an environment determination for determining whether a variation satisfying a predetermined condition has occurred to the utilization environment of the plurality of image forming apparatuses based on the collected information about the utilization environment;
executing control, if an error has frequently occurred and the utilization environment has varied, for notifying information indicating that the error has frequently occurred together with information about the varied utilization environment; and
executing control, if the error has frequently occurred and the utilization environment has not varied, for notifying information indicating that the error has occurred together with the information about the utilization environment.

14. A method executed by an apparatus, the method comprising:
collecting, from a plurality of image forming apparatuses, information about a status of occurrence of an error occurring on the plurality of image forming apparatuses and an utilization environment in which the plurality of image forming apparatuses is utilized;
executing an error determination for determining whether an error has frequently occurred on the plurality of image forming apparatuses within a predetermined time period based on the collected information about the status of occurrence;
executing an environment determination for determining whether a variation satisfying a predetermined condition has occurred to the utilization environment of the plurality of image forming apparatuses based on the collected information about the utilization environment; and
executing control, if an error has frequently occurred and the utilization environment has not varied, for notifying information indicating that the error has occurred together with information indicating that the error has occurred due to a cause different from the utilization environment.

15. The method according to claim 14, further comprising:
grouping the plurality of image forming apparatuses into a plurality of groups;
calculating a first statistic value by processing the information about the occurrence of the error for each group, and determining whether the error has frequently occurred for each group based on the calculated first statistic value;
calculating a second statistic value by processing the information about the utilization environment for each group, and determining whether the utilization environment has varied for each group based on the calculated second statistic value; and
executing control for notifying information indicating that the error has occurred in the group together with supplemental information about the utilization environment according to a result of the determining the environmental.

16. A non-transitory computer-readable storage medium storing instructions which, when executed by a computer, cause the computer to perform operations comprising:
collecting, from a plurality of image forming apparatuses, information about a status of occurrence of an error occurring on the plurality of image forming apparatuses and an utilization environment in which the plurality of image forming apparatuses is utilized;
executing an error determination for determining whether an error has frequently occurred on the plurality of forming apparatuses within a predetermined time period based on the collected information about the status of occurrence;
executing an environment determination for determining whether a variation satisfying a predetermined condition has occurred to the utilization environment of the plurality of image forming apparatuses based on the collected information about the utilization environment;
executing control, if an error has frequently occurred and the utilization environment has varied, for notifying information indicating that the error has frequently occurred together with information about the varied utilization environment; and
executing control, if the error has frequently occurred and the utilization environment has not varied, for notifying information indicating that the error has occurred together with the information about the utilization environment.

17. The storage medium according to claim 16, further comprising:
grouping the plurality of image forming apparatuses into a plurality of groups;
calculating a first statistic value by processing the information about the occurrence of the error for each group, and determining whether the error has frequently occurred for each group based on the calculated first statistic value;
calculating a second statistic value by processing the information about the utilization environment for each group, and determining whether the utilization environment has varied for each group based on the calculated second statistic value; and
executing control for notifying information indicating that the error has occurred in the group together with supplemental information about the utilization environment according to a result of the determining the environmental.

18. A non-transitory computer-readable storage medium storing instructions which, when executed by a computer, cause the computer to perform operations comprising:
collecting, from a plurality of image forming apparatuses, information about a status of occurrence of an error occurring on the plurality of image forming apparatuses and a utilization environment in which the plurality of image forming apparatuses is utilized;
executing an error determination for determining whether an error has frequently occurred on the plurality of image forming apparatuses within a predetermined time period based on the collected information about the status of occurrence;
executing an environment determination for determining whether a variation satisfying a predetermined condition has occurred to the utilization environment of the plurality of image forming apparatuses based on the collected information about the utilization environment; and
executing control, if an error has frequently occurred and that the utilization environment has not varied, for notifying information indicating that the error has occurred together with information indicating that the error has occurred due to a cause different from the utilization environment.

19. The storage medium according to claim 18, further comprising:
grouping the plurality of image forming apparatuses into a plurality of groups;
calculating a first statistic value by processing the information about the occurrence of the error for each group, and determining whether the error has frequently occurred for each group based on the calculated first statistic value;
calculating a second statistic value by processing the information about the utilization environment for each group, and determining whether the utilization environment has varied for each group based on the calculated second statistic value; and
executing control for notifying information indicating that the error has occurred in the group together with supplemental information about the utilization environment according to a result of the determining the environmental.
